(19) United States
(12) Patent Application Publication
(10) Pub. No.: US 2025/0365543 A1
(43) Pub. Date: Nov. 27, 2025

(54) HEARING AID

(71) Applicant: Shenzhen Flysounds Medical Technology Co, Ltd., Shenzhen (CN)

(72) Inventor: Shoukun Peng, Shenzhen (CN)

(21) Appl. No.: 18/984,741

(22) Filed: Dec. 17, 2024

(30) Foreign Application Priority Data
May 24, 2024 (CN) 2024106694344

(51) Int. Cl. H04R 25/00; H05B 3/06

(52) U.S. Cl. CPC H04R 25/305; H04R 25/603; H05B 3/06; H04R 2225/025; H04R 2225/61; H05B 2203/007; H05B 2203/014

(57) ABSTRACT

A hearing aid includes: a housing including a base and a flip cap deposed on the base in a turnover manner, where the base is provided with a first groove configured to accommodate an ear-in part of an earphone, a second groove configured to accommodate a body of the earphone, a third groove provided in the second groove and configured to accommodate a controller, and a fourth groove that communicates with the third groove and is configured to accommodate a lanyard; and a heating component, where the base is provided with an inner cavity, and the heating component is disposed in the inner cavity, and is wrapped around and sleeved on the first groove, the second groove, the third groove, and the fourth groove. According to the hearing aid, the heating component is disposed as a three-dimensional grid structure, to reduce a size of a heating device.

### TECHNICAL FIELD

This application relates to the technical field of hearing aids, and in particular, relates to a hearing aid.

### BACKGROUND

With gradual ageing of the popularization, a proportion of the aging population in China is increasing. As the elderly have significant sensory deficiencies, for example, significant degradation in senses such as hearing and vision, a plurality of products emerge on the market to alleviate the sensory degradation problem of the elderly, such as presbyopic glasses and a hearing aid.

After long-time use, especially long-time use in a humid environment, the hearing aid may have a moisture residue problem. When there is redundant moisture on the hearing aid, the moisture may enter the hearing aid through a hole on the hearing aid, affecting a normal function of the hearing aid.

Therefore, a hearing aid maintenance system is disclosed in a patent application document EP3697104A1 in which circulation of hot air in a hearing aid is implemented through a heater and a fan, and moisture in the hearing aid is dried through heating during hot air circulation. However, in this patent application document, a size of the hearing aid is undoubtedly increased due to the large heater disposed inside a housing of the hearing aid, and an uneven temperature problem is easily caused in each electronic component of the hearing aid by a fan circulating manner. In addition, a heating temperature of the heater should not be too high to avoid impact of a high temperature on the electronic component at a local region inside the housing of the hearing aid. However, a poor moisture drying capacity caused by a low temperature at a connecting part of the electronic component or another opening part may affect a service life of the hearing aid as the moisture enters the electronic component through the opening part or the connecting part of the electronic component.

### SUMMARY

In view of this, it is necessary to provide a hearing aid with a small size and a good drying effect, to resolve the problem.

Embodiments of this application provide a hearing aid, including:
a housing including a base and a flip cap deposed on the base in a turnover manner, where the base is provided with a first groove configured to accommodate an ear-in part of an earphone, a second groove configured to accommodate a body of the earphone, a third groove provided in the second groove and is configured to accommodate a controller, and a fourth groove that communicates with the third groove and is configured to accommodate a lanyard; and
a heating component, where the base is provided with an inner cavity, and the heating component is disposed in the inner cavity, and is wrapped around and sleeved on the first groove, the second groove, the third groove, and the fourth groove.

According to the hearing aid provided in this application, the heating component is manufactured into a three-dimensional grid structure capable of being wrapped around and sleeved on the first groove, the second groove, the third groove, and the fourth groove, to reduce a size of a heating device. In addition, the heating component is sleeved around the ear-in part of the earphone, the body of the earphone, and the controller, and there is an opening and a gap at a joint and the like of the controller and the lanyard, such that when the heating component is configured to heat, moisture at the opening or gap can be dried better, and moisture can be prevented from entering the earphone through the opening or the gap, ensuring the service life of the hearing aid.

### BRIEF DESCRIPTION OF THE DRAWINGS

FIG. 1 is a schematic diagram of a three-dimensional structure of a hearing aid according to an embodiment of this application;

FIG. 2 is an exploded view of the hearing aid shown in FIG. 1; and

FIG. 3 is a schematic diagram of fitting of a first groove and a first heating part shown in FIG. 1.

### DESCRIPTION OF SYMBOLS OF MAIN ELEMENTS

100, hearing aid; 10, housing; 11, base; 11a, first groove; 111a, first winding surface; 111b, first arc-shaped surface; 111c, second arc-shaped surface; 11b, second groove; 11c, third groove; 11d, fourth groove; 12, flip cap; 20, heating component; 21, first heating part; 211, first heat producing part; 212, fixed part; 213, heat producing element; 214, connecting part; 22, second heating part; 23, third heating part; 24, fourth heating part; 30, earphone; 31, ear-in part; 32, body; 40, controller; and 50, lanyard.

### DETAILED DESCRIPTION OF THE EMBODIMENTS

The embodiments of this application are described below with reference to the accompanying drawings in the embodiments of this application. It is apparent that the described embodiments are merely some rather than all of the embodiments of this application.

It should be noted that when a component is considered to be “connected” to another component, the component may be connected to the another component directly, or indirectly via an intermediate component. When a component is considered to be “arranged on” another component, the component may be directly arranged on the another component or there may be an intermediate component The terms “top”, “bottom”, “upper”, “lower”, “left”, “right”, “front”, “rear”, and similar expressions used in this specification are used for illustrative purposes only.

Some embodiments of this plication are described in detail below with reference to the accompanying drawings. If no conflict occurs, the following embodiments and features of the embodiments may be combined with each other.

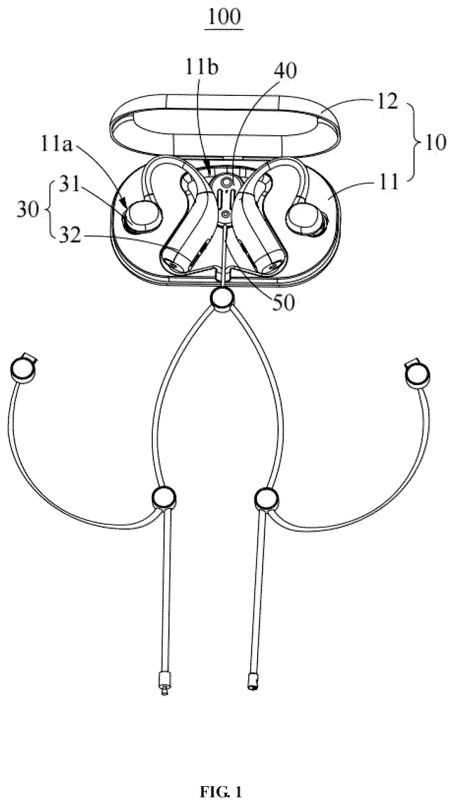

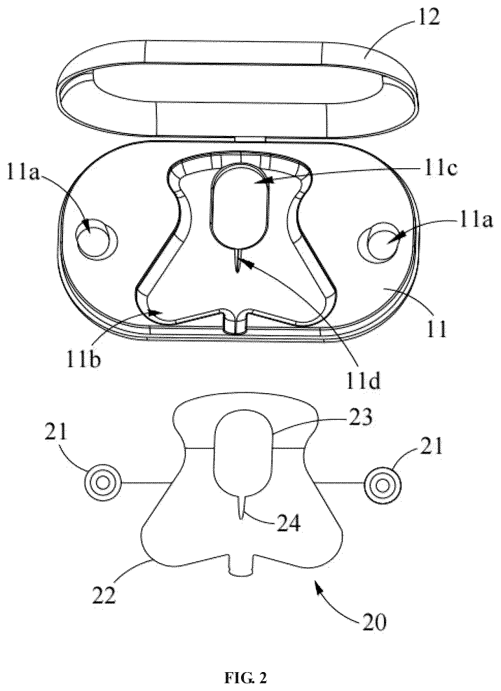

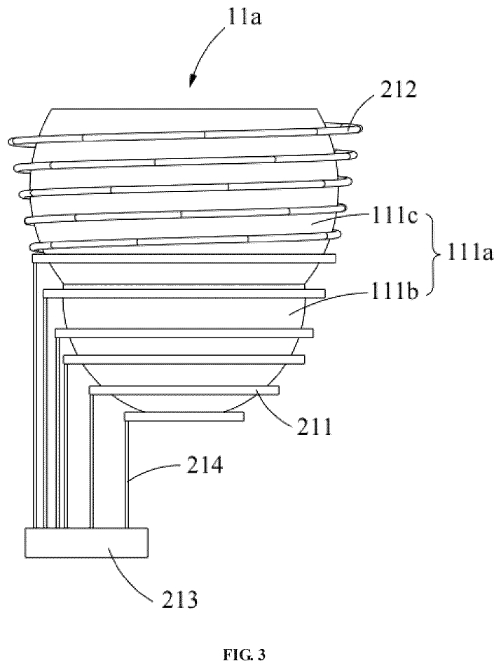

Refer to FIG. 1 to FIG. 3. This application provides a hearing aid 100, including a housing 10, and a heating component 20. The housing 10 includes a base 11 and a flip cap 12 deposed on the base 11 in a turnover manner, where the base 11 is provided with a first groove 11a configured to accommodate an ear-in part 31 of an earphone 30, a second groove 11b configured to accommodate a body 32 of the earphone 30, a third groove 11c provided in the second groove 11b and configured to accommodate a controller 40, and a fourth groove 11d that communicates with the third groove 11c and is configured to accommodate a lanyard; 50. The base 11 is provided with an inner cavity (not shown in the figures), and the heating component 20 is disposed in the inner cavity, and is wrapped around and sleeved on the first groove 11a, the second groove 11b, the third groove 11c, and the fourth groove 11d.

It should be noted that, in this application, the base 11 is provided with a surface facing the flip cap 12. To be specific, an upper surface of the base 11, the first groove 11a, the second groove 11b, the third groove 11c, and the fourth groove 11d are provided on the surface.

In a specific embodiment, a shape of the heating component 20 is consistent with that of the surface. To be specific, the three-dimensional heating component 20 is positioned in the inner cavity and is wrapped around and sleeved on the first groove 11a, the second groove 11b, the third groove 11c, and the fourth groove 11d, such that when the hearing aid 100 is used in a humid environment or the hearing aid 100 is humid due to long-time use, the heating component 20 is configured to heat up and dry the hearing aid 100 through heating to evaporate moisture in the hearing aid 100, achieving a dry environment, and avoiding a problem that a service life of the hearing aid 100 is affected as moisture at an opening and a hole on the hearing aid 100 in the humid environment enters the hearing aid 100 through the opening and the hole.

Further, the heating component 20 is formed by winding heating wires. Compared with an existing product (for example, a product in a patent application document EP3697104A1) in which a heater is disposed in the hearing aid 100, in this application, the existing heating device is replaced with the heating component 20 formed by wrapping heating wires, thereby greatly reducing an overall size and an overall weight of the hearing aid 100, and facilitating carrying by the elderly.

In another specific embodiment, the heating component 20 may alternatively be an electric heating film.

Further, the first groove 11a is configured to accommodate the ear-in part 31 of the earphone 30, the second groove 11b is configured to accommodate the body 32 of the earphone 30, the third groove 11c is configured to accommodate the controller 40, and the fourth groove 11d is configured to bear a connecting part 214 between the controller 40 and the lanyard 50. The parts have openings or splicing seams or the connecting parts between the lanyard 50 and an electronic device have large or small holes, namely, parts that moisture easily enters when there is moisture in the hearing aid 100. In this application, the heating component 20 is wound around the parts to heat up the openings or holes for evaporating the moisture, thereby achieving a dry environment and avoiding influence of the moisture on the hearing aid 100.

In a specific embodiment, the heating component 20 includes a first heating part 21, a second heating part 22, a third heating part 23, and a fourth heating part 24, where the first heating part 21 is wrapped around and sleeved on a surface, in the inner cavity, of the first groove 11a, the second heating part 22 is wrapped around and sleeved on a surface, in the inner cavity, of the second groove 11b, the third heating part 23 is sleeved on a surface, in the inner cavity, of the third groove 11c, and the fourth heating part 24 is wrapped around and sleeved on a surface, in the inner cavity, of the fourth groove 11d.

In a specific embodiment, the first heating part 21, the second heating part 22, the third heating part 23, and the fourth heating part 24 each are formed by winding one heating wire. During winding, one heating wire is separately wound on the first groove 11a, the second groove 11b, the third groove 11c, and the fourth groove 11d to form the first heating part 21, the second heating part 22, the third heating part 23, and the fourth heating part 24.

It may under understood that, in another specific embodiment, the first heating part 21, the second heating part 22, the third heating part 23, and the fourth heating part 24 each may alternatively be formed by winding a plurality of heating wires. Details are as follows.

Specifically, the first groove 11a is provided with a first winding surface 111a in the inner cavity. The first winding surface 111a includes a first arc-shaped surface 111b and a second arc-shaped surface 111c that are sequentially disposed. The first arc-shaped surface 111b is disposed opposite to a sound outlet of the ear-in part 31 of the earphone 30, and the second arc-shaped surface 111c is wrapped around the first groove 11a. The first heating part 21 includes a first heat producing part 211 and a fixed part 212 disposed on the first heat producing part 211, where the first heat producing part 211 is wound on the first arc-shaped surface 111b, and is configured to produce heat on the first arc-shaped surface 111b, and the fixed part 212 is wound and fixed on the second arc-shaped surface 111c.

It should be noted that, the first heat producing part 211 is disposed on the first arc-shaped surface 111b, such that when the heating component 20 is configured to produce heat on the heat producing part, most of the produced heat is centralized on the heat producing part. The heat producing part is disposed opposite to the sound outlet of the earphone 30, such that when much heat is centralized on the heat producing part, space at the sound outlet of the earphone 30 can be dried with the much heat to form a dry environment. Further, in this application, heat is intensively produced on the heat producing part, to avoid a problem that a function and a service life of the entire hearing aid 100 are affected by an excessively high temperature of another part as a heating temperature is deliberately increased to ensure an important part to reach a specified temperature during unified heating of the entire heating component 20.

Further, the fixed part 212 is wound on the second arc-shaped surface, to improve connection firmness between the heating component 20 and the base 11.

In a specific embodiment, the first heat producing part 211 and the fixed part 212 are integrally formed.

To produce heat only on the heat producing part, in a specific embodiment, the first heating part 21 further includes a heat producing element 213. There are a plurality of first heat producing parts 211, where the plurality of first heat producing parts 211 are connected to the heat producing element 213, and the plurality of first heat producing parts 211 are disposed in a circle, to be wound around in the first groove 11a.

It should be noted that, to alleviate a heat loss problem during heat propagation, in the foregoing embodiment, the plurality of heating wires are wound to form the plurality of first heat producing parts 211, and the plurality of first heat producing parts 211 are connected to the heat producing element 213. When the heat producing element 213 is configured to produce heat, the plurality of first heat producing parts 211 can be configured to: directly receive heat on the heat producing element 213 and transmit the heat to the first arc-shaped surface, thereby drying and heating the sound outlet of the earphone 30 by centralizing most heat.

Preferably, in the foregoing embodiment, each first heat producing part 211 is disposed in a circle, avoiding the heat loss problem during heat propagation at the first heat producing part 211.

It should be noted that, when heat is transferred in the solid heating wire or another solid, the heat conduction is performed mainly through vibration of atoms or molecules. In addition, vibrations of atoms or molecules in a high-temperature area are fiercer than those of atoms or molecules in a low-temperature area. Therefore, under collision of the molecules, heat is transferred from a hot end to a cold end, and heat loss in a transfer process is caused by kinetic energy attenuation because of heat loss to air and collision between the molecules. In the conventional technology, when one heating wire is wound to transfer heat, a part, away from the heat producing part, of the heating wire usually has heat loss because of a large length, causing a problem that the heating wire is partially not utilized, and further causing a problem that a utilization rate of the heating wire is low. In this application, the plurality of first heat producing parts 211 are disposed, and each first heat producing part 211 is disposed in a circle, thereby avoiding a problem that a utilization rate of the first heat producing part 211 is low due to heat loss caused by an excessively large length of the first heat producing part 211, saving materials, reducing costs, and improving drying efficiency.

Further, the first heating part 21 further includes a plurality of connecting parts 214, and each heat producing part is fixed to the heat producing element 213 through one of the connecting parts 214.

In a specific embodiment, the plurality of first heat producing parts 211, the plurality of connecting parts 214, and the heat producing element 213 are integrally formed.

It should be noted that, in a specific embodiment, the connecting part 214 is the heating wire. The heat producing element 213 is a block-shaped resistor heater including a block-shaped heating block. The connecting part 214 is also of a heating wire structure, and is integrally formed. Preferably, when each first connecting part 214 is connected to the heat producing element 213 and one first heat producing part 211, each heat producing part is sequentially arranged downward in a vertical direction. That is, in the vertical direction, the plurality of first heat producing parts 211 are disposed around the first arc-shaped surface at equal spacings to heat up different parts of the first arc-shaped surface, thereby improving heating efficiency and avoiding a problem that a local region is excessively heated up due to overlapping of different first heat producing parts 211. In addition, a heating area and heating efficiency are improved to a greatest extent.

Further, to help the heat producing element 213 produce heat, in a specific embodiment, the hearing aid 100 further includes a power supply module (not show in the figures). The power supply module is disposed in the inner cavity of the base 11, and is connected to the heat producing element 213, and configured to produce heat on the heat producing element 213. Specifically, in this embodiment, the heat producing element 213 is an electric heating block, or the like.

To prevent the hearing aid 100 from being damaged due to over-heating of the hearing aid 100 or avoid affecting a service life of the hearing aid 100, in a specific embodiment, the hearing aid 100 further includes a temperature sensor (not shown in the figures). The temperature sensor is disposed in the inner cavity of the base 11, is electrically connected to the power supply module, and is configured to control the power supply module to be disconnected while detecting that a temperature in the base 11 reaches a threshold.

It should be noted that, in a production process of the hearing aid 100, an electronic component in the hearing aid 100 is detected to obtain a minimum temperature at which any component is damaged. The temperature is set as a threshold temperature of the temperature sensor. The temperature sensor is disposed in the base 11 to detect the minimum temperature at which any electronic component is damaged. Therefore, when the interior of the hearing aid 100 reaches the threshold temperature, the temperature sensor controls the power supply module to be disconnected to disconnect the heat producing element 213, thereby stopping producing heat to prolong the service life of the hearing aid 100.

To disconnect the heat producing element 213 better, in a specific embodiment, the hearing aid 100 further includes a fuse. The fuse is disposed in the inner cavity of the base 11, is electrically connected between the temperature sensor and the power supply module, and is configured to disconnect the power supply module while receiving a signal indicating that a temperature transmitted from the temperature sensor reaches the threshold.

It should be noted that, the power supply module, the temperature sensor, and the fuse are parts in the prior art, and specific principles thereof are described in detail again.

The hearing aid 100 further includes a lanyard 50, to facilitate carrying by the elderly.

According to the hearing aid 100 provided in this application, the heating component 20 is disposed, and the heating component 20 is manufactured into a three-dimensional grid structure capable of being wrapped around and sleeved on the first groove 11a, the second groove 11b, the third groove 11c, and the fourth groove 11d, to reduce a size of a heating device. In addition, the heating component 20 is sleeved around the ear-in part 31 of the earphone 30, the body 32 of the earphone 30, and the controller 40, and there is an opening and a gap at a joint and the like of the controller 40 and the lanyard 50, such that when the heating component 20 is configured to heat, moisture at the opening or gap can be dried better, and moisture can be prevented from entering the earphone 30 through the opening or the gap, ensuring the service life of the hearing aid 100.

The above described are merely implementations of this application. It should be noted herein that those of ordinary skill in the art may make improvements without departing from the concept of this application, but such improvements should fall within the protection scope of this application.

What is claimed is:

1. A hearing aid, comprising:
a housing comprising a base and a flip cap deposed on the base in a turnover manner, wherein the base is provided with a first groove configured to accommodate an ear-in part of an earphone, a second groove configured to accommodate a body of the earphone, a third groove provided in the second groove and configured to accommodate a controller, and a fourth groove that communicates with the third groove and is configured to accommodate a lanyard; and
a heating component, wherein the base is provided with an inner cavity, and the heating component is disposed in the inner cavity, and is wrapped around and sleeved on the first groove, the second groove, the third groove, and the fourth groove.

2. The hearing aid according to claim 1, wherein the heating component comprises a first heating part, a second heating part, a third heating part, and a fourth heating part; and
the first heating part is wrapped around and sleeved on a surface, in the inner cavity, of the first groove, the second heating part is wrapped around and sleeved on a surface, in the inner cavity, of the second groove, the third heating part is sleeved on a surface, in the inner cavity, of the third groove, and the fourth heating part is wrapped around and sleeved on a surface, in the inner cavity, of the fourth groove.

3. The hearing aid according to claim 2, wherein the first heating part, the second heating part, the third heating part, and the fourth heating part each are formed by winding one heating wire.

4. The hearing aid according to claim 2, wherein the first groove is provided with a first winding surface in the inner cavity;
the first winding surface comprises a first arc-shaped surface and a second arc-shaped surface that are sequentially disposed, wherein the first arc-shaped surface is disposed opposite to a sound outlet of the ear-in part of the earphone, and the second arc-shaped surface is wrapped around the first groove; and
the first heating part comprises a first heat producing part and a fixed part disposed on the first heat producing part, wherein the first heat producing part is wound on the first arc-shaped surface, and is configured to produce heat on the first arc-shaped surface, and the fixed part is wound and fixed on the second arc-shaped surface.

5. The hearing aid according to claim 4, wherein the first heating part further comprises a heat producing element; and
there are a plurality of first heat producing parts, wherein the plurality of first heat producing parts are connected to the heat producing element, and the plurality of first heat producing parts are disposed in a circle, to be wound around in the first groove.

6. The hearing aid according to claim 5, wherein the first heating part further comprises a plurality of connecting parts, wherein
each heat producing part is fixed to the heat producing element through one of the connecting parts.

7. The hearing aid according to claim 6, wherein the plurality of first heat producing parts, the plurality of connecting parts, and the heat producing element are integrally formed.

8. The hearing aid according to claim 5, wherein the hearing aid further comprises a power supply module, wherein
the power supply module is disposed in the inner cavity of the base, and is connected to the heat producing element, and configured to produce heat on the heat producing element.

9. The hearing aid according to claim 8, wherein the hearing aid further comprises a temperature sensor, wherein
the temperature sensor is disposed in the inner cavity of the base, is electrically connected to the power supply module, and is configured to control the power supply module to be disconnected while detecting that a temperature in the base reaches a threshold.

10. The hearing aid according to claim 9, wherein the hearing aid further comprises a fuse, wherein
the fuse is disposed in the inner cavity of the base, is electrically connected between the temperature sensor and the power supply module, and is configured to disconnect the power supply module while receiving a signal indicating that a temperature transmitted from the temperature sensor reaches the threshold.
